(19) United States
(12) Patent Application Publication
(10) Pub. No.: US 2008/0162308 A1
(43) Pub. Date: Jul. 3, 2008

(54) Creation and use of automated, agent-free baseline inventory of assets system

(76) Inventor: Arvind Sharma, Menlo Park, CA (US)

Correspondence Address: RONALD CRAIG FISH, A LAW CORPORATION, PO BOX 820, LOS GATOS, CA, 95032, US

(21) Appl. No.: 11/647,994

(22) Filed: Dec. 29, 2006

(51) Int. Cl. G06Q 10/00

(52) U.S. Cl. 705/28

(57) ABSTRACT

Methods of doing business which revolve around an automated computer-based, agentless asset discovery system to develop inventory information for use in various business processes. The automated inventory information is developed for multiple data centers to be consolidated into one data center to aid in the consolidation and an automated inventory of the consolidated data center is used to resolve any discrepancies. An automated inventory of servers and the applications and data on them is used for consolidating servers. An automated inventory of servers, other IT assets and application programs and operating systems is compared to invoices from outside vendors managing them for reviewing invoices, and automated inventories of application programs and operating systems are compared to license agreements for license negotiations.

### FIELD OF USE AND BACKGROUND OF THE INVENTION

Companies and governments experience many transformations wherein knowledge of all the assets they have would be useful to know. By assets, we mean computers, software on those computers, printers, faxes, network hubs, gateways and servers, routers, leases and other contracts, license agreements, etc.

Examples of events wherein knowledge of such assets is useful include server consolidation, data center consolidation or a data center move to a new location, creation of disaster recovery centers, validating invoices from vendors to which projects have been outsourced, software audits by software producers.

Audits of the assets of a company manually is time consuming and expensive and slow. Some prior art systems exist for computerized inventory, but they use agent programs which must be manually installed on every piece of equipment coupled to a network. These agent programs cannot assist in inventory of pieces of equipment upon which they cannot be installed nor can they assist in inventory of non Information Technology assets such as license agreements, leases, etc.

Therefore, a need has arisen for a system which can take automated inventory of a company's assets without the use of agent programs loaded on every piece of equipment the company has and which can use the gathered inventory information in various ways to assist in the types of transformations of a company's operations mentioned above.

### BRIEF DESCRIPTION OF THE DRAWINGS

FIG. 1 shows schematically a network environment, a system to automatically inventory the network environment to determine what assets are there, and types of transformations or other events in the life of a business where knowledge of the assets in the network environment is useful.

FIG. 2 is a block diagram of the general hardware architecture of a BDNA inventory system which can carry out an automated asset discovery process to determine the assets in a target IT environment to which it is connected.

FIG. 3 is a flow chart of the business method to use an automated IT asset inventory to do server consolidation.

FIG. 4 is a pie chart wherein each sector represents a segment of servers that meet a predefined subset of all the criteria used in selecting servers for elimination.

FIG. 5 is a diagram showing a physical data center consolidation into one data center to illustrate the flow of assets that underlies the process of FIG. 6.

FIG. 6 is a flow chart of the business method according to one embodiment of the invention to consolidate multiple data centers into one data center.

FIG. 7 is a diagram illustrating the physical steps of a data center and asset consolidation process.

FIG. 8 is a flowchart of the business method according to another embodiment which consolidates both servers and business centers and moves only the consolidated assets.

FIG. 9 is a diagram of the process for using an automated inventory system to gather inventory data to enable verification of invoices generated by another entity managing those resources.

FIG. 10 is a flowchart of one embodiment of a business method to use an automated inventory system generated inventory of at least some of the assets of an enterprise to check invoice line items on invoices received from vendors to whom management of IT assets has been outsourced.

FIG. 11 is a diagram showing a business method showing how an automated asset inventory of a data center and a disaster recovery data center can be used advantageously to ensure that the disaster recovery center always has copies of the data and applications critical to the operation of a business.

FIG. 12 is a diagram of the environment in which a business process to conduct a baseline inventory of the installed software in an enterprise and negotiate renewal license negotiations or copyright infringement litigation discovery is performed.

### SUMMARY OF THE INVENTION

The principle of the invention is that business processes such as negotiating with an insurance company for insurance coverage, consolidating servers or data centers, creating a disaster recovery center or recovering from a disaster, negotiating for a software license or validating a invoice from a vendor etc. may be done more easily, more quickly, more inexpensively and more accurately using automated inventory of assets. The fundamental steps common to all the methods of doing business described here are: 1) take an automated inventory of at least some of the assets of an entity such as a company or government entity; 2) compare the inventory with some information appropriate to the type of business transaction or event being carried out; and 3) take some appropriate action based upon the comparison. Each different species within this genus does different things during each of these steps to accomplish the desired end result. Some species have additional steps. Some steps can only be performed manually such as moving assets from multiple data centers to a consolidated data center. Other steps can be performed either manually or by a suitably programmed computer such as consolidating servers onto a fewer number of servers.

Examples include: 1) The automated inventory information is developed for multiple data centers to be consolidated into one data center to aid in the consolidation, and an automated inventory of the consolidated data center is used to resolve any discrepancies; 2) An automated inventory of servers and the applications and data on them is used for consolidating servers; 3) An automated inventory of servers, other IT assets and application programs and operating systems is compared to invoices from outside vendors managing them for reviewing invoices; 4) An automated inventory of application programs and operating systems are compared to license agreements for license negotiations.

### DETAILED DESCRIPTION OF THE PREFERRED AND ALTERNATIVE EMBODIMENTS

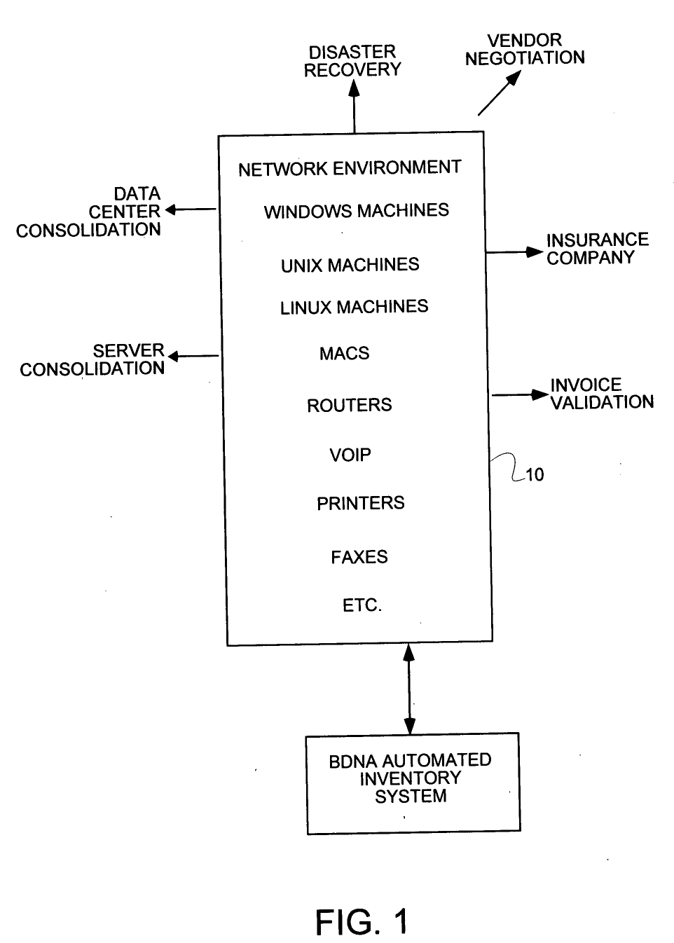

FIG. 1 shows schematically a network environment, a system to automatically inventory the network environment to determine what assets are there, and types of transformations or other events in the life of a business where knowledge of the assets in the network environment is useful. Block 10 represents a typical network environment which may contain computers with Windows® operating systems, Unix® operating systems, Linux® operating systems, Macintosh® operating systems, routers, Voice-Over-IP equipment, printers, faxes and other Information Technology equipment. Other assets a company has such as leases on office space or license agreements on software may also be present.

Information about the assets in the network environment and the company in general is useful during data center consolidations, server consolidations, disaster recovery and creating of disaster recovery centers, vendor negotiations, negotiations with insurance companies for insurance, and validation of invoices from vendors to whom various projects have been outsourced.

Information about the assets in a company and its network environment can be automatically gathered without the use of agents using a system which is commercially available from BDNA Inc. of Mountain View, Calif. and which is described in U.S. Pat. No. 6,988,134, which is hereby incorporated by reference. The claim language “automated inventory” should be interpreted to include the technology of U.S. Pat. No. 6,988,134 as well as any other automated asset inventory system whether agent based or not.

As examples of how knowledge of the inventory of assets a company has is useful for various scenarios common in large business operations, consider the following. Suppose a company outsources the process of managing its IT assets to a third party vendor. That vendor then uses whatever process it uses to conduct an inventory of the company's IT assets and submits an invoice to the company. The outsourcer is providing information to the company about the current state of its IT assets, but the Company has no way of knowing whether the invoice is correct because it has no idea what is current state of IT assets is, since these assets have been outsourced. If the company had a automated inventory process that collects technical information from its servers, etc. and generates an automated inventory, that company can then compare the automated inventory to the invoice for the work the vendor did to validate the entries on the invoice.

In the area of disaster recovery, businesses typically have one or more data centers and a disaster recovery center. It is important to keep the disaster recovery center synchronized with the other data centers in terms of the IT equipment it has, the software installed thereon and up to date copies of the files stored on the data center servers and client computers if any.

Software audits are also events which happen in big businesses. Software audits are carried out by vendors of software to determine if a licensee is in compliance with its license agreement. License contracts with vendors and software manufacturers/distributors are often based upon the number of copies of a software application installed in various computers in the company. A software audit can result in an unanticipated expense if a company is not in compliance with its license agreement. If an automated inventory is taken which includes the number of copies of various software applications installed on various computers within a company, this information can be compared to the desired license or the existing license agreement and a determination made about pricing and renewal rates and surprises from a software audit can be avoided. Current prior art consists of collecting information manually about the number of copies of software titles installed by making a specific data call to IT managers and system administrators (typically a spreadsheet emailed to them) asking for relevant information. Other prior art consists of collecting data in automated fashion using agent programs which are installed on computers in a company's network(s). The agents collect data about the software applications installed and sometimes about the amount of usage of the software, and send it back to a data collection server.

In the area of insurance, insurance companies set the rates for their coverage policies based upon the amount of assets they are insuring. During policy periods, it often happens that servers are retired, new servers are added, servers are consolidated, software is retired or new software is added, data compilations grow etc. To take an inventory manually at every renewal is slow, expensive and usually inaccurate so it is useful to have the ability to take an automated inventory of assets owned or in use by a company or government agency at the time of policy renewal so that negotiations can be carried out from a position of strength based upon a good knowledge of what assets an entity has.

In the area of data center consolidation or data center moves, it is useful to know which assets each data center has to eliminate unwanted duplication and to eliminate the need to move servers or software or data which already exists in another location. The prior art includes systems to take inventories of network assets to establish a baseline using agent-based discovery and/or manual entry. This is slow, expensive and subject to human error. It is useful to take an automated, fast and accurate inventory of assets before a data center consolidation or move and then inspect the results in order to decide which servers to consolidate or move and make any other decisions appropriate to the proposed event.

In the area of server consolidation, it is useful to know which applications and data files are stored on which servers so that consolidation to eliminate unnecessary duplication can be made. To do server consolidation, an asset owner or outside contractor contracted to do the consolidation needs a baseline view of all assets which could be candidates for server consolidation. These candidates may be decided on multiple different criteria such as the CPU/memory combination of the server, the age of the server, the operating system installed on the server, the applications running on the server, etc. These are all data elements that are captured in the automated inventory step of the business method taught herein.

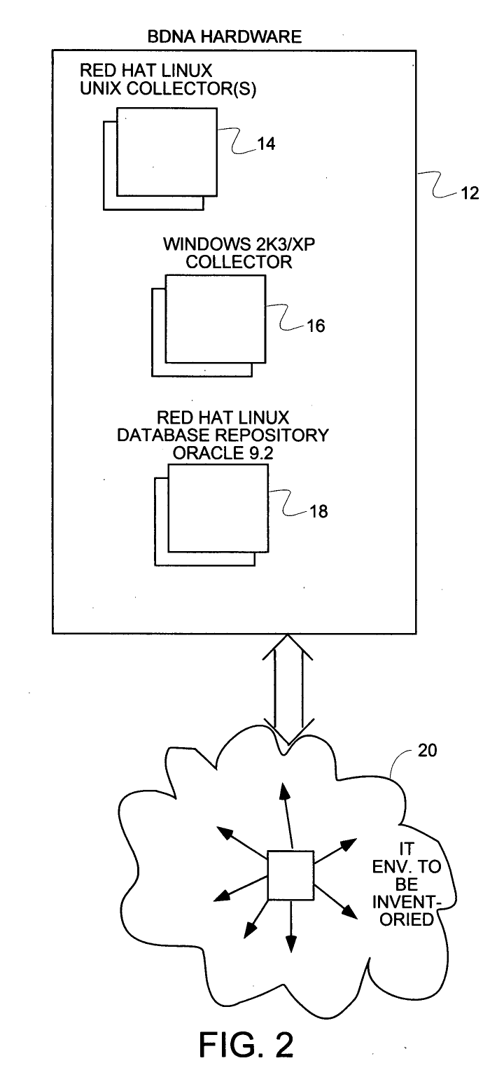

FIG. 2 is a block diagram of the general hardware architecture of a BDNA inventory system which can carry out an automated asset discovery process to determine the assets in a target IT environment to which it is connected. In a typical automated asset inventory system using the BDNA automated inventory software, one or more computers 14 running Red Hat Linux operating system execute a portion of the BDNA inventory software system and are coupled to the IT environment 20 to be inventoried. One or more computers 16 running Windows 2003/XP as operating system and running part of the BDNA inventory software application are coupled to the IT environment 20 to be inventoried. One or more computer 18 running Redhat Linux and Oracle 9.2 or 10g database software serves to store the inventory information gathered by the other computers in the system. The reason a separate computer is used to run the database application is that the automatic inventory application can be quite intensive when it is running, and a dedicated database prevents slowing the inventory application down. In a less intense inventory application, the database function can be combined with the inventory application on one or a cluster of computers that run both applications.

The reason computers running Linux and Windows are needed is because is that Windows machines in the IT environment to be inventoried speak only the language of Windows so Windows machines must be used in the BDNA automated inventory system must be used to gather data from those machines. The computer(s) running the Linux operating system 14 are used to gather attributed data about all the other machines in the IT environment to be inventoried. If Microsoft and its peculiarities did not exist, there would be no need for computers 16.

The IT environment to be inventoried can be one or more networks which are coupled or independent but which are all coupled to the BDNA automated inventory collection system. Other automated inventory collection systems may also be used other than the BDNA system so long as they can generate a good baseline inventory. The BDNA automated inventory system is preferred since it does not use agents that have to be installed on every machine in the IT environment.

The computers in the system use scripts or “collection instructions” for each attribute type to log onto and gather information from or otherwise query the various machines in the IT environment to be inventoried to gather information. “Fingerprints” are used to compare the collected data to a template to try to ascertain what type of machine, operating system or software the element from which the attribute data was gathered is. The collection instructions detail how to gather information about particular attributes of the type of machine to which the collection instruction pertains. Each attribute of each element type has a collection instruction.

A “collection instruction” is a program, script, or list of instructions to be followed by an agent computer called a “data collector” to gather attribute data of a specific attribute for a specific element (asset) or gather attribute data associated with a group of element attributes. For example, if the type of an unknown operating system on a particular computer on the network is to be determined, the “collection instruction” will, in one embodiment, tell the collection gateway to send a particular type or types of network packets that has an undefined type of response packet. This will cause whatever operating system is installed to respond in its own unique way. Fingerprints for all the known or detectable operating systems can then be used to examine the response packet and determine which type of operating system is installed. Another example of a “collection instruction” is as follows. Once the operating system has been determined, it is known what type of queries to make to that operating system over which protocols to determine various things such as: what type of computer it is running on; what file system is mounted; how to determine which processes (computer programs in execution) are running; what chip set the computer uses; which network cards are installed; and which files are present in the file system. A “collection instruction” to find out, for example, which processes are actually in execution at a particular time would instruct the agent to send a message through the network to the operating system to invoke a particular function call of an application programmatic interface which the operating system provides to report back information of the type needed. That message will make the function call and pass the operating system any information it needs in conjunction with that function call. The operating system will respond with information detailing which processes are currently running as listed on its task list etc.

A “fingerprint” is a definition of the partial or complete identity of an asset by a list of the attributes that the asset can have. The list of attributes the asset will have is a “definition” and each attribute either contains a link to a “collection instruction” that controls a data collector to obtain that attribute data for that element or directly includes the “collection instruction” itself. Hereafter, the “definition” will be assumed to contain for each attribute a pointer to the “collection instruction” to gather that attribute data. For example, if a particular application program or suite of programs is installed on a computer such as the Oracle Business Intelligence suite of e-business applications, certain files will be present in the directory structure. The fingerprint for this version of the Oracle Business Intelligence suite of e-business applications will, in its included definition, indicate the names of these files and perhaps other information about them. The fingerprint's definition will be used to access the appropriate collection instructions and gather all the attribute data. That attribute data will then be post processed by a data collector process to format the collected data into the element/attribute format for each attribute of each element defined in data structure #1. Then the properly formatted data is stored in the collected data store defined by data structure #4 which is part of the common data store. Further processing is performed on the collected data to determine if the attributes of an element are present. If they are sufficiently present, then the computer will be determined to have the Oracle Business Intelligence suite of e-business applications element installed. In reality, this suite of applications would probably be broken up into multiple elements, each having a definition defining which files and/or other system information need to be present for that element to be present.

Fingerprints are used to collect all types of information about a company and identify which assets the company has from the collected information. In one sense, a fingerprint is a filter to look at a collected data set and determine which assets the company has from that data. Almost anything that leaves a mark on an organization can be “fingerprinted”. Thus, a fingerprint may have attribute definitions that link to collection instructions that are designed to determine how many hours each day each employee in each different group within the company is working. These collection instructions would typically send e-mails to supervisors in each group or to the employees themselves asking them to send back reply e-mails reporting their workload.

A fingerprint must exist for every operating system, application program, type of computer, lease, license or other type of financial data or any other element that the system will be able to automatically recognize as present in the business organization.

Each attribute in an element/attribute data structure has a pointer to its collection instruction and, when the collection instruction is executed, data about an instance of that attribute is gathered and stored in a data store in computer 18. Post processing of the collected data is done to make it conform to the field lengths and data types of the element/attribute data structure. Conforming the data allows different applications to run to present or represent the data in a uniform way or do cross-correlation or mathematical combinations or comparisons for purposes of analysis.

All attributes of all types of machines that the system can recognize are recorded in a common data structure called an element/attribute data structure. This is a generic way to describe all information, but there is a different, specific element/attribute entry for each attribute of each element the system can recognize.

The descriptions of the type and length of datafields defining the element/attribute relationships are stored in three logical tables. One table stores the element descriptions, another table stores the descriptions of the type and length of each attribute field, and a third table stores the mapping between each element and the attributes which defines its identity in a “fingerprint”. Containment relationships are defined in another table.

More information about the prior art BDNA automatic inventory system can be gleaned from study of U.S. Pat. No. 6,988,134.

### Sever Consolidation Process

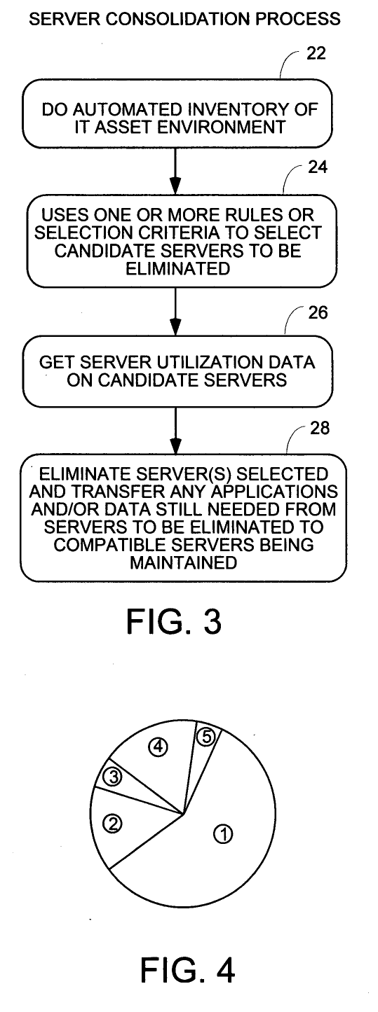

FIG. 3 is a flow chart of the business method to use an automated IT asset inventory to do server consolidation. Step 22 represents the process of doing an automated inventory of the IT assets of a company. This process can be carried out in the manner described in U.S. Pat. No. 6,988,134 or in the manner of any other prior art automated inventory of assets of a company known in the prior art. For example, Microsoft makes a product which inventories assets in an IT environment but which requires agent programs to be installed on all the machines in the IT environment. These agent programs gather data and send it to an inventory server.

Whatever process is used, it must result in a baseline inventory of the IT assets which includes the servers of a company and at least enough information about those servers to enable selection of the servers for consolidation in step 24.

Step 24 can be a manual step or it can be automated and involves looking at the baseline inventory developed in step 22 and using the rule or rules that are driving the server consolidation to select the servers to consolidate. Server consolidation may be driven by such factors as: the desired to eliminate servers supplied by a particular vendor; a need to eliminate old servers that are no longer supported by the manufacturer and which are requiring cannibalization of other machines to keep running; a need to eliminate servers running a particular version of an operating system of some version or earlier which is no longer supported by the manufacturer; a need to eliminate servers that are older than X years or which have proved to be unreliable; a need to eliminate servers which are running some application program which is no longer needed; a need to eliminate servers which certain CPU/RAM combinations such as servers that have less disk space or RAM or are slower than some of the newer desktop machines in the IT environment, etc.

For example, a rule can be set up which says, “If we have any Unix servers with less than 1 gigabyte of RAM, they will be phased out and their applications and data files will be transferred to newer, better servers.”

Another typical rule might be, “If we have any servers running Oracle applications, they are to be eliminated as we do not need that application any longer, and any applications also run on a server which we still need is to be transferred to another server.”

Another typical rule might be related to return on investment, such as, “We want a return on investment of X %. If we have more servers than we need to achieve that return on investment, then we need to eliminate some servers and consolidate the applications running on the eliminated servers onto servers capable of running those applications.”

The rules obviously depend upon the business considerations of the particular business involved and the particular rules used are not part of the invention.

Step 26 represents the process of getting utilization data of the servers (all servers but in some embodiments, only the utilization of the candidate servers to be eliminated is obtained). The claim language “server utilization data” should be interpreted to mean either collecting all server utilization data or just server utilization data of servers which have been designated as candidates to be eliminated. The utilization data may be any one or more things of interest such as: number of users logged in to each server as a function of time; CPU utilization; memory utilization; disk utilization, etc. Typically this data is gathered by an agent based system which uses agents to gather data of the desired type or types from each server periodically over time and stores it. The data can be displayed as a graph over time where the time scale can be expanded. Analysts then examine the CPU utilization data to determine if there is a pattern to the usage of each server and whether the patterns of usage indicate one or more servers can be combined onto one server without exceeding the capacity of the remaining server to do work. For example, two servers running the same application may have patterns of utilization which are the inverse of each other such that when one server is down for backup, the usage of the other server increases. By combining these two servers into one server, a relatively constant usage of the server's capacity of the remaining server can be obtained.

Typical prior art server consolidation processes take between 60-65% of the time to implement the consolidation in gathering data about what servers exist and what data and applications they have on them and selecting candidate servers using one or more criteria. By using the automated IT environment inventory system, especially the one supplied by BDNA, the time to carry out a server consolidation, substantially shortens. Typically, using the automated inventory system shortens the time to gather the data needed to select the candidate servers for elimination to about 20% of the total time to implement the consolidation. This means that 80% of the time of the prior art consolidation processes can be devoted to the actual elimination and consolidation of servers. This means the process can be done in shorter time at lower cost because 80% of the prior art time is not needed to do the consolidation or the consolidation can be done at a higher quality.

Step 28 represents the process of eliminating the servers selected for elimination in the consolidation process and transferring any application programs still needed from those servers to other servers which are not going to be eliminated and any associated data. Step 28 is done manually, but step 24 can be done either manually or with a computer as can step 26.

It is possible that step 24 to select servers can be accomplished based upon a number of criteria using a pie chart such as that illustrated in FIG. 4. FIG. 4 is a pie chart wherein each sector represents a segment of servers that meet a predefined subset of all the criteria used in selecting servers for elimination. For example, sector 1 may represent the number of servers that are manufactured by Sun. Sector 2 may represent the number of servers that are manufactured by Sun and are older than 10 years old. Sector 3 may represent the number of servers manufactured by Sun and that are running some predetermined version of Oracle database software that is no longer supported by the manufacturer. Sector 4 may represent the number of servers manufactured by Microsoft. Sector 5 may represent the number of servers that are no longer supported by their manufacturers. In other examples, each sector may include the same basic factors with one or more factors added on such that each sector includes the same factors as the sector before as well as additional factors. The selection of the number of servers to phase out may then be made in some embodiments using the return on investment model. Specifically, whatever the return on investment is that management decides it needs is used as the criteria to decide how many servers to phase out. The pie chart is then used to find the sector which has at least that many servers and the specific servers represented by that sector are then examined to determine if there are any data files or application programs that have to be moved to other servers to be retained. The claim language “set of one or more rules to select candidate servers to be eliminated” should be interpreted to include using the return on investment model or any other criteria to decide which servers to eliminate.

### Data Center Consolidation Process

Sometimes companies acquire other companies, and, in the process, acquire data centers that do the same sorts of things that are done in the data centers already existing in the acquiring company. Other times, a company may develop multiple data centers over time such as when a company is doing well early in its existence and then falls on harder times such as when its technology becomes obsolete. This happened to IBM and Digital Equipment Corporation. Whatever the reason, it sometimes happens that a company will wind up having more data centers than it needs, and data center consolidation is needed to save costs.

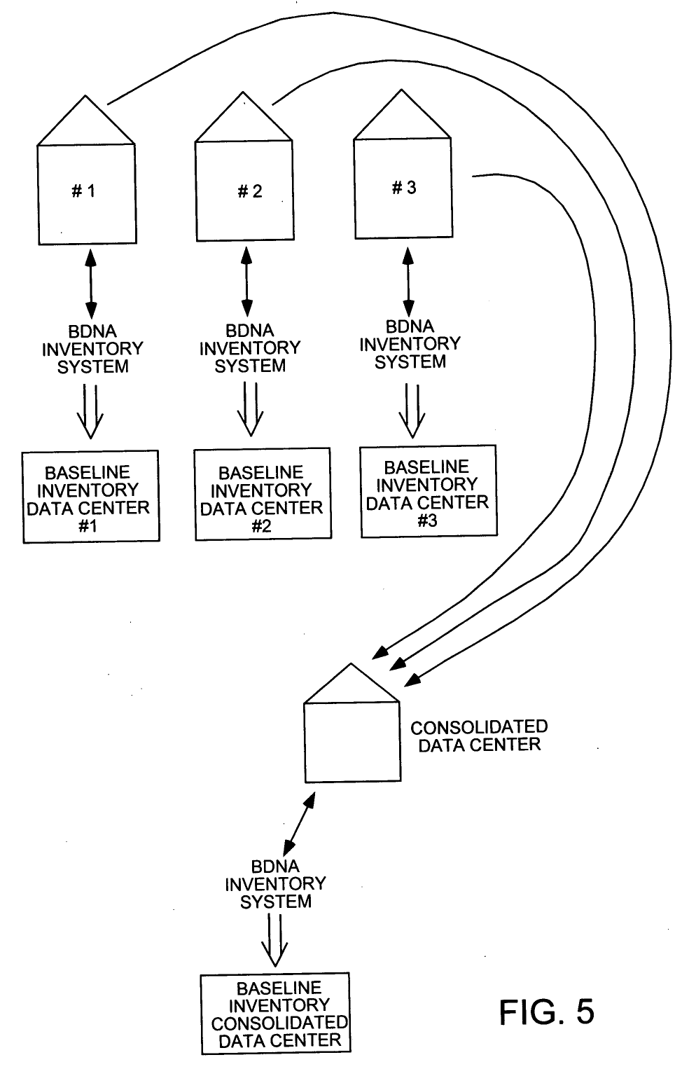

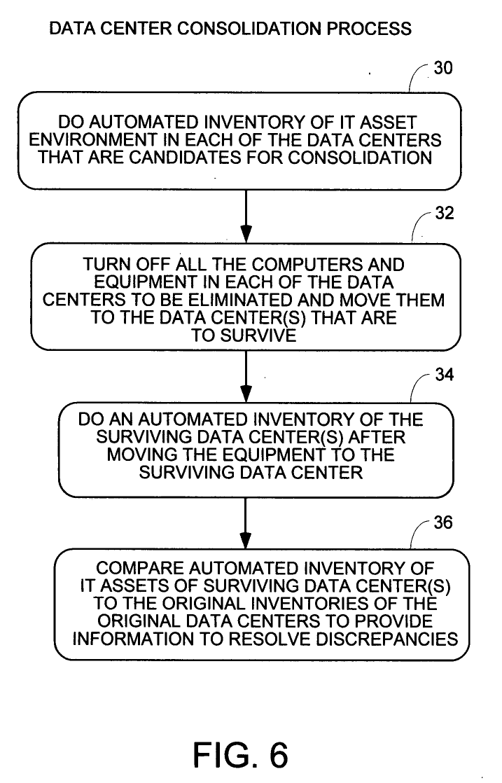

FIG. 5 is a diagram showing a physical data center consolidation into one data center to illustrate the flow of assets that underlies the process of FIG. 6. An automated inventory of the assets of each of a plurality of data centers #'s 1 to 3 is done using the BDNA inventory system of some other automated inventory system. The BDNA system is preferred because it does not use agents and it can acquire information about non IT assets such as leases, software licenses, etc.

After a baseline inventory of each data center is obtained, the physical assets of each data center are physically moved to the consolidated data center. Once the assets have been moved and the IT assets have been re-coupled to the network(s), another automated inventory using the BDNA inventory system or similar and a baseline inventory of the consolidated business center is generated. This baseline inventory of the consolidated data center is checked against the baseline inventories of the original three data centers to determine if any asset was not moved, was damaged in the move and is not responding or disappeared during the moving process.

As an example of a business method to do data center consolidation per the teachings of the invention, please consider the following hypothetical example where three data centers which are geographically disparate and which are to be combined into one data center. Referring to FIG. 5, there is shown a flow chart of the business method according to one embodiment of the invention to consolidate multiple data centers into one data center. Step 30 comprises the process of using an automated inventory program to conduct automated inventories of all the assets of the IT environments of each of the data centers to be eliminated. These automated inventory results are then stored. Step 32 represents the process of turning off all the computers and equipment in each of the data centers to be eliminated and moving them to the data center(s) to be retained, and coupling them to the network.

Things can get lost or stolen or damaged in these moves since typically thousands of items have to be moved in an enterprise level business. To ensure that all the assets made the transition and are still responding on the network, step 34 is performed to perform an automated inventory of the IT assets of the surviving data center after the move has been accomplished and all the moved equipment has been coupled to the network.

Step 36 involves comparing the new inventory of the surviving data center resulting from step 24 to the original inventories of the data centers which were shut down to determine if anything is missing and provide baseline information to enable resolution of discrepancies. Typically the baseline inventories of each of the data centers to be consolidated will be manually combined into one baseline inventory to facilitate this comparison step. However, the claims should be interpreted to include both doing this consolidation as well as separate comparisons to each of the individual baseline inventories taken of the data centers to be eliminated because combination of the inventories is not essential in every embodiment.

### Combined Data Center Center And Server Consolidation

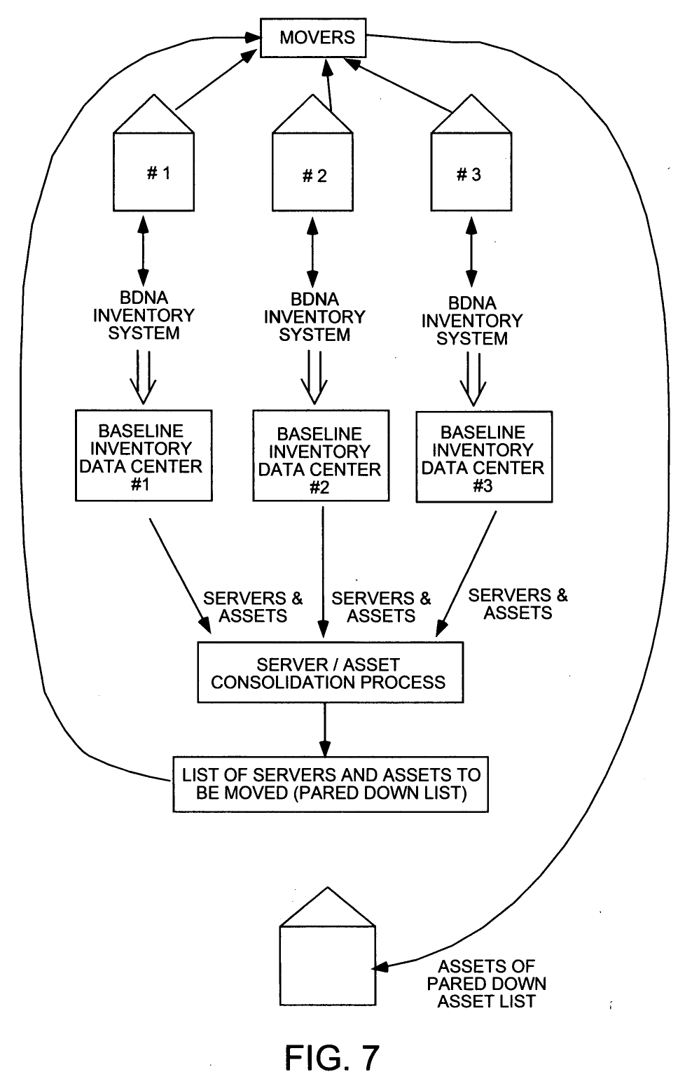

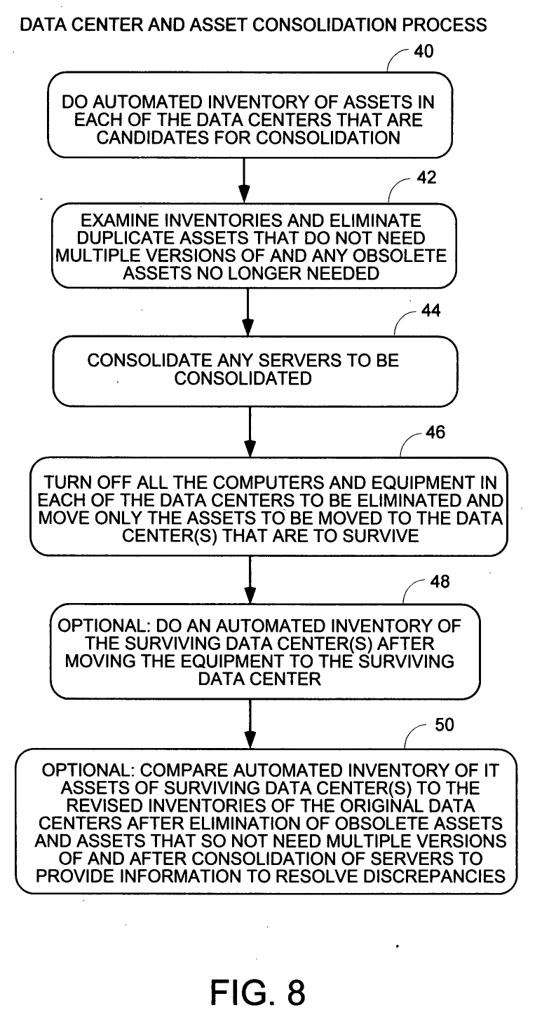

As conditions in a business change, it often happens that a need to consolidate data centers develops to lower costs. Because duplicates of assets in different data centers that would not be needed if the data centers were consolidated exist and because servers might need to be consolidated for the reasons discussed above, it is convenient to consolidate assets and servers at the same time data centers are consolidated to avoid the expense of moving unneeded assets and maintaining them and housing them and insuring them once they are moved. FIG. 7 is a diagram illustrating the physical steps of a data center and asset consolidation process. In the example, three data centers are to be consolidated into one data center. FIG. 8 is a flowchart of the business method of one embodiment which consolidates both servers and business centers and moves only the consolidated assets after consolidation of servers and elimination of duplicate or unneeded assets.

To explain this process, FIGS. 7 and 8 will be referred to simultaneously. First, in step 40, the BDNA automated inventory system or similar (the phrase or similar is intended to include other prior art automated inventory systems) is used to conduct a baseline inventory of each of the data centers to be consolidated to develop a list of all the assets in each data center.

In step 42, the inventories automatically generated of the assets in each data center are examined and any assets that exist in multiple data centers which would be duplicates of each other in the consolidated data center are eliminated. Also, any obsolete assets which will no longer be needed in the surviving consolidated data center(s) are eliminated. Finally, the server consolidation process previously described is performed in step 44.

After all the consolidation processing is done (it is usually done manually by IT technicians), all the computers, servers, printers, etc. of all the data centers are turned off in each of the data centers to be eliminated. Then, only the assets remaining after the consolidation process are moved to the surviving data center(s) and are reconnected to the enterprise network, as symbolized in step 46. In some embodiments, this is done in stages so that the enterprise is never without an operating data center.

Steps 48 and 50 are optional. In step 48, an automated inventory of the surviving data center or centers is done using the BDNA automated inventory system or similar after the surviving assets have been moved in and connected. In step 50, the automatically generated inventory of the surviving data center or centers is compared to the original inventories of the original data centers after those inventories have been pared down to reflect the elimination of obsolete and/or duplicate assets and after elimination of servers discarded in the server consolidation process. Step 50 can be done using an automated asset reconciliation process implemented by software supplied by BDNA of Mountain View, Calif. This software implements the process described in a U.S. patent application filed Mar. 21, 2005 Ser. No. 11/111,562 entitled ITERATIVE ASSET RECONCILIATION PROCESS published on Aug. 10, 2006 under publication number US 2006-0178954 A1 which is hereby incorporated by reference. In the claims, the claim language “asset reconciliation process” should be interpreted to include the automated asset reconciliation process taught in U.S. patent application filed Mar. 21, 2005 Ser. No. 11/111,562 or any other automated process that can compare one inventory of IT assets to one or more other inventories of IT assets or by doing a manual comparison of the inventories.

If everything that was supposed to be moved did not show up on the automated inventory of the consolidated data center, then an exceptions list is generated in some embodiments, and a manual investigation is conducted to find out what happened. Sometimes moving companies lose assets, and sometimes they are broken in transit and no longer respond on the network after being reconnected, etc.

### Outsourcing

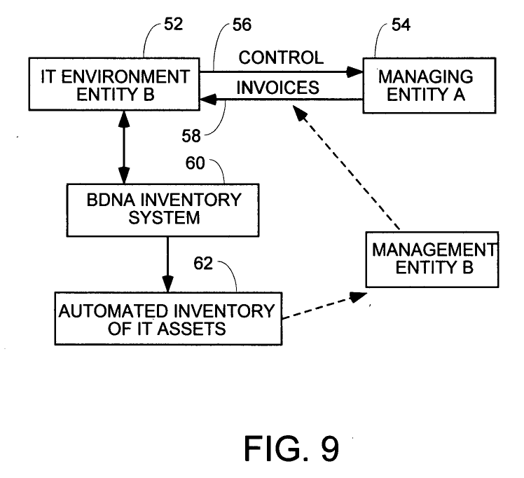

Sometimes entities outsource management of their IT assets and help desk functions to outside contractors. FIG. 9 is a diagram of the process for using an automated inventory system to gather inventory data to enable verification of invoices generated by another entity managing those resources. Entity B owns a plurality of IT assets in its IT environment. Those assets of entity B are being managed by entity A 54 which is an outsourcing specialist which specializes in managing enterprise level IT assets and manning a help desk. This control or assignment of assets to entity A is represented by line 56. Line 56 may represent complete transfer of both hardware and software assets to entity A or transfer of hardware assets with entity A retaining software licenses. It can also represent a partial transfer of some of the hardware and/or software assets to entity A. Various services that entity A may perform upon instruction from entity B include, for example: 1) upgrade the memory on all the client computers from 256K to 512K; 2) install new versions of MS Office on all client computers; 3) find and tabulate all instances of installations of Oracle 10g and report the number of CPUs upon which Oracle 10g is installed. Entity A will perform the services and then send an invoice 58 for the work to entity B. The invoice will usually have line items describing the service performed and the cost, e.g., installed MS Office version X on 5,192 client computers at the cost of $12 per upgrade; managed 26 servers at the cost of Y dollars per month; searched 5,192 client computers and 26 servers for instances of installation of software Z and generated a report at a cost of $405.

Management of entity A, when it receives this invoice, does not have exact information about how many servers and client computer it has in the IT environment being managed by entity A. When it receives such an invoice, it can either approve it in the blind trusting the entity A is fairly representing the number of assets being managed and the work done or it can review the invoice in detail and seek verification to support each line item. When entity B is an enterprise class business like the Disney company, a government entity or a large government contractor with thousands of IT assets being managed, gathering information about what IT assets it has and what software is installed on each can be a very time consuming and expensive task if done manually.

To avoid this problem for management, the BDNA automated inventory system 60 is coupled to the IT environment 52 and conducts an automated inventory of all the assets in the environment being managed to generate an automated inventory 62. The automated inventory details how many servers and how many client computers are in the IT environment 52 and which versions of software are installed on each. This allows management of entity B to verify how many client computers and servers it has so as to verify some of the line items of the invoice 58, and it allows management of entity B to determine whether or not MS Office version X has been installed on all the client computers etc. so as to be able to verify other line items of invoice 58. Typically, the automated inventory will be conducted once per month so as to have a fresh inventory to check each new invoice with.

### Automated Inventory in Support of Invoice Review

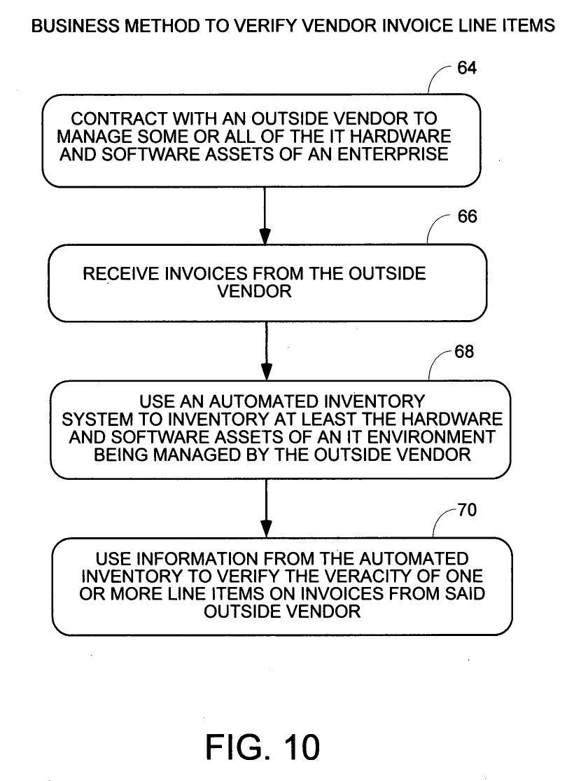

FIG. 10 is a flowchart of one embodiment of a business method to use an automated inventory system generated inventory of at least some of the assets of an enterprise to check invoice line items on invoices received from vendors to whom management of IT assets has been outsourced. In FIG. 10, step 64 represents the manual process of contracting with an outside vendor to manage at least some of the IT assets of a business. Step 66 represents the process of receiving invoices from the outside vendor to which management of the IT assets has been assigned. Step 68 represents the process of using an automated asset inventory system to generate an accurate inventory of at least some of the assets of an enterprise, including a significant number or all of the assets being managed by the outside vendor.

Step 70 represents the process of using the inventory generated in step 68 to verify the veracity of one or more line items on invoices from said outside vendor. Typically, steps 68 and 70 are done once a month or every time an invoice is received from such a vendor.

### Disaster Recovery Business Method

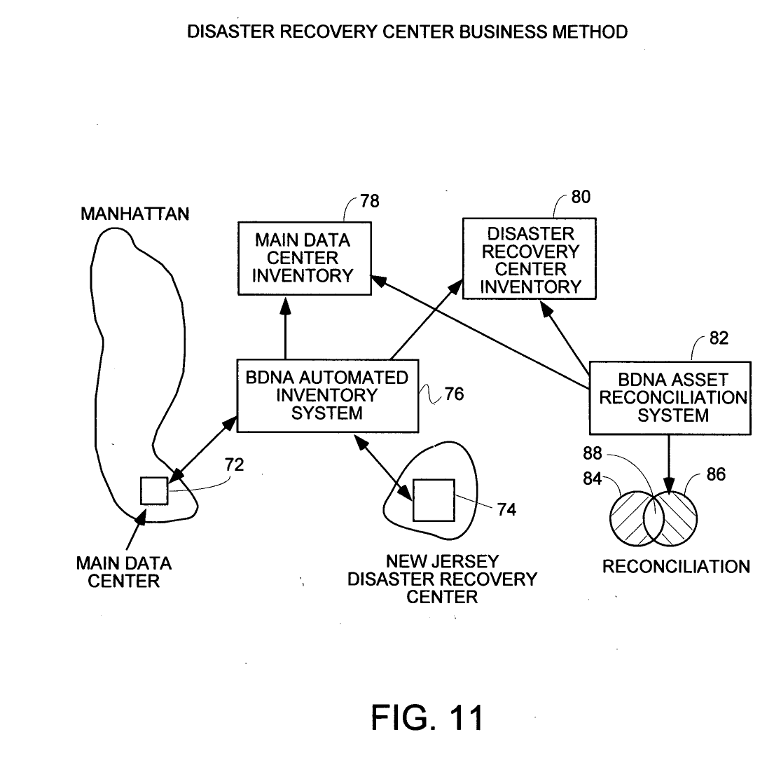

As the 9/11 and hurricane Katrina disasters demonstrated, hugely catastrophic events can do tremendous damage to cities. If those cities happen to have a data center in them, and the enterprise owning the data center has no backup disaster recovery data center, then the destruction of a data center can be extremely disruptive to the operations of a business. It is therefore wise to have a disaster recovery center which has backups of at least all the critical data pertinent to current operations of a business and backup copies of all the application programs and operating systems and servers which are necessary to current operations of the business. FIG. 11 is a diagram showing a business method showing how an automated asset inventory of a data center and a disaster recovery data center can be used advantageously to ensure that the disaster recovery center always has copies of the data and applications critical to the operation of a business.

In the example of FIG. 11, an entity has a data center 72 located in some location which is subject to risk of loss of the data center, such as Florida. The data center is comprised of multiple servers, possibly many client computers, software installed on each of the computers and numerous other assets such as routers, hubs, switches, printers, FAXes, etc. and data critical to the operation of the business The enterprise has a disaster recover center 74 located somewhere out of harm's way which it will rely upon for operations if the main data center is destroyed. The enterprise wishes to be able to rely on having this backup data center at all times ready and available to take over all operations of the entity. In order to do this, the disaster recovery data center must have backup copies of all data and application programs on the hard drives of the main data center which are critical to operations. The disaster recover center must also have sufficient number and quality of servers and client computers to handle the load of the main data center.

To ensure this is the case, the BDNA automated asset inventory system 76 or similar may be used to conduct automated inventories of the servers, client computers, installed application software, data files and other assets in each of the main data center and the disaster recovery data center. The inventory of the main data center is symbolized by block 78. The inventory of the disaster recovery center is symbolized by block 80. A reconciliation of these two inventories can then be performed to determine if the backup data center has all the application programs and data it needs and enough server, client computers, routers, gateways, hubs, switches, etc. to assume operations of the main data center. This asset reconciliation process may be carried out using a system 82 such as the BDNA asset reconciliation system which is described in U.S. patent application entitled ITERATIVE ASSET RECONCILIATION PROCESS, filed Apr. 21, 2005, Ser. No. 11/111,562, which is hereby incorporated by reference. The reconciliation process results in a reconciliation report that shows the assets 84 that the data center 72 has but the disaster recovery center 74 does not have, the assets 86 that the disaster recovery center 74 has but the main data center 72 does not have and the assets 88 which both the data center and the disaster recovery center have. The data center 72 may have production servers, test servers, development servers, all of which may not be needed at the disaster recovery center. The disaster recovery center may only need production servers. Generally, a mirror image of the assets, application programs and data is a desirable thing.

### Enterprise License Negotiation Method

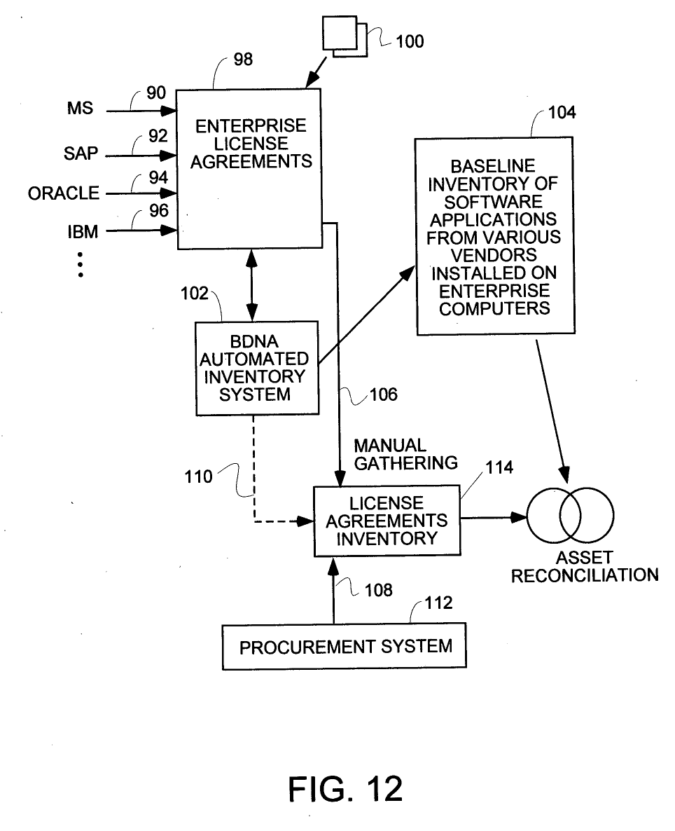

FIG. 12 is a diagram of the environment in which a business process to conduct a baseline inventory of the installed software in an enterprise and negotiate renewal license negotiations or copyright infringement litigation discovery is performed. A large enterprise may have thousands or tens of thousands of installations of various software applications on its servers and client computers. These software applications are installed under license agreement restrictions that limit the number of copies that may be installed or limit the number of users that may use an application program installed on a server. When an enterprise is large, it is very difficult to manage compliance with all the different license agreements with the various software vendors. For example, in a typical large enterprise there will be installed thousands of copies of Microsoft operating systems and application programs, represented by line 90, on the enterprise servers and client machines. Many different installations of software from SAP 92, Oracle 94 and IBM 96 may also exist as well as installations from other vendors.

To further complicate matters, large entities frequently buy smaller companies or merge with other companies, represented by block 100. Those other companies with have numerous installations of software under license from their own vendors so it is unlikely that any manager in either entity will have a full picture of exactly how many pieces of each type of licensed software are installed over the whole enterprise.

The collections of license agreements from the various vendors is represented by block 98. Each may have different line items and terms and conditions that need to be satisfied, so there is a need for a detailed inventory of which applications are installed in which places in the enterprise and how many copies of each. In addition, the IT department may need to know which service packs and versions of operating systems are installed on the various computers in the enterprise since many versions of Microsoft operating systems are vulnerable to virus and worm attacks from the internet if they do not have the various patches installed which have been provided by Microsoft in response to newly discovered threats.

To obtain this detailed inventory, an automated inventory system such as the BDNA automated inventory software 102 which is commercially available from the assignee of the invention may be used, or some other automated inventory system may also be used. There are automated inventory systems which used installed agents on the various computers in the enterprise to gather information about what is installed on each computer and when it is used. However, as far as the applicants are aware, these agent-based systems are unable to inventory which license agreements the enterprise has. The BDNA automated inventory system 102 is not agent based and has protocols in it to inventory for license agreements by sending emails to the appropriate persons in the enterprise with the knowledge asking them to send back information they may have as to the details of license agreements to which the enterprise is bound.

The resulting inventory of software applications installed on the various computers in the enterprise is represented by box 104.

Next, an inventory of the license agreements the enterprise is bound by is needed. Box 98 represents the license agreements that have been signed that are still in force, but which the managers of the enterprise may or may not know exist. Typically, a manual gathering of information about what license agreements the enterprise has is performed, as represented by solid lines 106 and 108. Manual inventories of license agreements are assisted by inspection of the records of the enterprise procurement system, represented by block 112. Usually when software is purchased, a record of the purchase is made in the computers of the procurement system of the enterprise. This will provide evidence of the existence of a software agreement somewhere and provide clues as to where to look during the manual inventory process. The manual process of inventorying to determine how many license agreements are in existence is often implemented by emailing out a spreadsheet which contains fields the users are requested to fill in by a certain data indicating what types of software license agreements they have and what the licensed number of copies are and any other pertinent information. Obviously the quality of the manual inventory results to determine the number of license agreements the enterprise is bound by depends greatly on how seriously the respondents take the emailed survey.

The resulting inventory of the license agreements the enterprise if bound by is represented by block 114.

Once all the license agreements have been located, and asset reconciliation process is performed either manually or automatically. The terms of the license agreements represented by block 114 are compared to the inventory of installed software applications to determine if compliance with the terms of the license agreements does or does not exist. Armed with this information about the numbers of software applications and operating systems installed in the enterprise and the terms of the license agreements, the enterprise is ready to negotiate with software vendors to renew licenses, add licenses, get price reductions or anything else the enterprise deems desirable.

In some embodiments, the BDNA automated inventory system 102 is used to do an automatic inventory of software license agreements in force by sending emails out to all IT managers and other managers of departments asking them to report back on the license agreements they know of. This automated inventory is represented by dashed line 110.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A method of doing business comprising:
A) using one or more computers to do an automated inventory of at least some of the assets of an entity;
B) comparing the results of said automated inventory to some information appropriate to a business transaction or event which is occurring or which is about to occur; and
C) taking some action appropriate to said transaction or event based upon said comparison.

2. The method of claim 1 further comprising the step of automatically or manually taking an inventory of software license agreements an enterprise is bound by and the terms thereof, and wherein step A comprises taking an automated inventory of all the application programs and operating systems installed on computers of an enterprise, and wherein step B comprises comparing the numbers of application programs and operating systems installed on computers of said enterprise against the provisions of said software license agreements located in said manual inventory of software license agreements, and wherein step C comprises negotiating with any licensor of said software license agreements in light of the information gathered about compliance or noncompliance with various software license agreements to obtain anything pertaining to said software license agreements deemed desirable by said enterprise.

3. The method of claim 1 wherein step A comprises conducting an automated inventory of all the assets and data files in a main data center and conducting an automated inventory of all the assets and data files in a disaster recovery data center, and wherein step B comprises comparing the inventories of assets in said main data center and said disaster recovery data center, and wherein step C comprises taking action to ensure that said disaster recovery center has sufficient assets and copies of data files to take over essential operations of said data center in case said main data center is destroyed or rendered inoperative.

4. The process of claim 1 wherein step A comprises using a automated inventory system to do an automated asset inventory of all the assets in an enterprise, and wherein step B comprises comparing the inventory results to a set of one or more rules to select candidate servers to be eliminated, and getting server utilization data and selecting one or more servers to be eliminated using said rules, and wherein step C comprises transferring any applications and/or data necessary to continue operations of said one more servers selected to be eliminated to one or more other servers and taking said one or more servers to be eliminated out of service.

5. A method of doing business comprising:
A) using one or more computers to do an automated inventory of the assets of a plurality of data centers operated by an enterprise to obtain a baseline inventory of the assets in each said data center;
B) physically moving the assets from each data center to a consolidated data center;
C) using one or more computers to do an automated inventory of the assets of said consolidated data center after the move;
D) comparing the results of said automated inventory of said consolidated data center to the automated inventories taken of each data center before the move to determine if there are any discrepancies; and
E) if there are discrepancies, taking some action appropriate to said transaction or event based upon said discrepancy.

6. A method of doing business comprising:
A) using one or more computers to do an automated inventory of the assets of a plurality of data centers operated by an enterprise to obtain a baseline inventory of the assets in each said data center;
B) examining the inventories of each data center and choosing assets to eliminate because they are duplicates of assets in other data centers and only one instance of such an asset is needed in a consolidated data center or because the asset is obsolete or not supported by its manufacturer any longer or for any other reason;
C) examining the inventories of servers in said plurality of data centers and choose servers to consolidate based upon any reason for consolidation, and consolidating servers by eliminating unneeded or obsolete servers and transferring application software and/or data from the eliminated servers to servers that will remain in a consolidated data center;
D) physically moving the assets that have not been eliminated from each data center to a consolidated data center.

7. The process of claim 6 further comprising the steps:
A) using one or more computers to do an automated inventory of the assets of said consolidated data center after the move;
B) comparing the results of said automated inventory of said consolidated data center to the automated inventories taken of each data center before the move to determine if there are any discrepancies; and
C) if there are discrepancies, taking some action appropriate to said transaction or event based upon said discrepancy.

8. The process of claim 6 wherein step D is done in stages such that the enterprise is not every without an operating data center which can fulfill the basic needs of the enterprise.

9. The process of claim 7 wherein step B is performed using an asset reconciliation process.

10. The process of claim 7 wherein step B includes generating an exception list and wherein step C comprises conducting a manual examination to determine what happened to missing assets.

11. A method of doing business comprising:
A) using one or more computers to do an automated inventory of the assets of a first entity whose IT environment is being managed by a second entity which sends invoices for the work done to said first entity;
B) comparing the results of said automated inventory to line items on an invoice from said second entity to check the accuracy of said line items before approving said invoice for payment; and
C) if there is some issue which becomes apparent from the comparison of step B, taking some action appropriate to resolving said issue.

12. A computer-readable medium having stored thereon computer-readable instructions which, when executed by a computer, can control said computer to do the automated parts of the following process:
A) controlling one or more computers to do an automated inventory of at least some of the assets of an entity;
B) comparing the results of said automated inventory to some information appropriate to a business transaction or event which is occurring or which is about to occur; and
C) taking some action appropriate to said transaction or event based upon said comparison.

13. The computer-readable medium of claim 12 wherein said computer-readable instructions further control a computer to perform the automated ones of steps A, B and C in the following manner:
D) controlling a computer to perform step A by taking an automated inventory of all the application programs and operating systems installed on computers of an enterprise and all the software license agreements binding said enterprise;
E) controlling a computer to perform step B by comparing the numbers of application programs and operating systems installed on computers of said enterprise against the provisions of said software license agreements located in a manual inventory of software license agreements.

14. The computer readable medium of claim 13 wherein said computer-readable instructions control said computer to perform step D by automatically sending out

15. The computer-readable medium of claim 12 wherein said computer-readable instructions further control a computer to perform the automated ones of steps A, B and C in the following manner:
D) controlling a computer to perform step A by conducting an automated inventory of all the assets and data files in a main data center and conducting an automated inventory of all the assets and data files in a disaster recovery data center;
E) controlling a computer to perform step B by comparing the inventories of assets in said main data center and said disaster recovery data center.

16. The computer-readable medium of claim 12 wherein said computer-readable instructions further control a computer to perform the automated ones of steps A, B and C in the following manner:
D) controlling a computer to perform step A to do an automated asset inventory of all the assets in an enterprise;
E) controlling a computer to perform step B by comparing the inventory results to a set of one or more rules to select candidate servers to be eliminated, and getting server utilization data and selecting one or more servers to be eliminated using said rules.

17. A computer-readable medium having stored thereon computer-readable instructions which, when executed by a computer, can control said computer to do the automated parts of the following process:
A) controlling one or more computers to do an automated inventory of the assets of a first entity whose IT environment is being managed by a second entity which sends invoices for the work done to said first entity;
B) comparing the results of said automated inventory to line items on an invoice from said second entity to check the accuracy of said line items before approving said invoice for payment; and
C) if there is some issue which becomes apparent from the comparison of step B, taking some action appropriate to resolving said issue.

18. A computer-readable medium having stored thereon computer-readable instructions which, when executed by a computer, can control said computer to do the automated parts of the following process:
A) controlling one or more computers to do an automated inventory of the assets of a plurality of data centers operated by an enterprise to obtain a baseline inventory of the assets in each said data center;
B) examining the inventories of each data center and choosing assets to eliminate because they are duplicates of assets in other data centers and only one instance of such an asset is needed in a consolidated data center or because the asset is obsolete or not supported by its manufacturer any longer or for any other reason;
C) examining the inventories of servers in said plurality of data centers and choose servers to consolidate based upon any reason for consolidation, and consolidating servers by eliminating unneeded or obsolete servers and transferring application software and/or data from the eliminated servers to servers that will remain in a consolidated data center;
D) physically moving the assets that have not been eliminated from each data center to a consolidated data center.

19. A computer-readable medium having stored thereon computer-readable instructions which, when executed by a computer, can control said computer to do the automated parts of the following process:
A) controlling one or more computers to do an automated inventory of the assets of a plurality of data centers operated by an enterprise to obtain a baseline inventory of the assets in each said data center;
B) after assets have been moved to a new consolidated data center, controlling one or more computers to do an automated inventory of the assets of said consolidated data center after the move;
D) controlling a computer to compare the results of said automated inventory of said consolidated data center to the automated inventories taken of each data center before the move to determine if there are any discrepancies.

20. A computer system comprising:
first means for doing an automated inventory of at least some of the assets of an entity; and
second means for comparing the results of said automated inventory to some information appropriate to a business transaction or event which is occurring or which is about to occur so as to provide information useful in deciding what course of action to take regarding said business transaction or event.

21. The system of claim 20 wherein said first means includes personnel taking manual inventory of software license agreements an enterprise is bound by as well as a computer programmed to take an agentless automated inventory of the application programs and operating systems installed on servers and client computers of said entity, and wherein said second means comprises either people who compare the terms of said license agreements to the results of said automated inventory of application programs and operating systems, or a computer programmed to make this same comparison.

22. The system of claim 20 wherein said first means comprises a computer programmed to take an agentless automated inventory of the assets of a main data center and a disaster data recovery center, and wherein said second means includes either people who compare the inventories of said main data center and said disaster recovery data center, or a computer programmed to make the comparison of inventories of said main data center and said disaster recovery data center.

23. A computer system comprising:
first means for doing an automated inventory of the assets of a plurality of data centers operated by an enterprise to obtain a baseline inventory of the assets in each said data center;
second means for doing an automated inventory of the assets of a consolidated data center after a move of assets from each of said data centers to said consolidated data center;
third means for comparing the results of said automated inventory of said consolidated data center to the automated inventories taken of each data center before the move to determine if there are any discrepancies.

24. A computer system comprising:
first means for doing an automated inventory of the assets of a first entity whose IT environment is being managed by a second entity which sends invoices for the work done to said first entity;
second means for comparing the results of said automated inventory to line items on an invoice from said second entity to check the accuracy of said line items before approving said invoice for payment so as to provide information to use in resolving any apparent billing discrepancies.
